(19) United States
(12) Patent Application Publication
(10) Pub. No.: US 2014/0063106 A1
(43) Pub. Date: Mar. 6, 2014

(54) Nano-Ranged Wide Color Gamut and Environmental-Friendly UV Inkjet Printing System

(71) Applicant: TAIWAN NANOTECHNOLOGY CORPORATION, Taichung City (TW)

(72) Inventors: Cheng-Yang Hsieh, Taichung City (TW); Cheng-Lin Liang, Taichung City (TW); Chih-Yang Lin, Taichung City (TW)

(73) Assignee: TAIWAN NANOTECHNOLOGY CORPORATION, Taichung City (TW)

(21) Appl. No.: 13/651,754

(22) Filed: Oct. 15, 2012

(30) Foreign Application Priority Data
Sep. 6, 2012 (TW) 101217191

(51) Int. Cl. B41J 2/205

(52) U.S. Cl. 347/15

(57) ABSTRACT

The present invention provides a nano-ranged wide color gamut and environmental-friendly UV inkjet printing system for a hard substrate comprising a carrier, an ink supplier, a printing head and a controller. The carrier receives the hard substrate thereon and the ink supplier includes a container space for containing an ink. The color gamut of the ink comprises basic colors of RYBK. The printing head receives the ink from the ink supplier, and the controller generates a control signal to control the printing head to spray coating the ink onto the surface of the hard substrate directly. The present invention is able to print the ink directly onto the surface of the hard substrate while utilizing the UV light for curing the ink into solid. The ink exhibits the physical properties of low surface tension, nano particles, environmental friendly, UV excitable, short duration of drying, great adhesiveness and high transparency.

### FIELD OF THE INVENTION

The present invention is related to an inkjet printing system, and in particular, to a nano-ranged wide color gamut and environmental-friendly ultraviolet (UV) inkjet printing system for hard substrates.

### BACKGROUND OF THE INVENTION

Conventionally, known inkjet inks can be categorized into different groups of water-based inks, solvent-based inks and ultraviolet-light curable inkjet ink, depending upon their compositions.

Among the known inkjet inks, the water-based inks are characterized by their low costs, and pollution-free and great color tone characteristics. However, the major composition of the water-based ink mostly involves water such that the volatilization speed of the ink is slower, which creates difficulties in drying and absorption by other mediums. This type of inks is mostly used on materials such as paper and substrates of various fibers such as fabrics or ones with coatings.

Furthermore, due to their weak weatherproof performance, the water-based inks are mainly for indoor uses. For outdoor applications, the solvent-based inks are mostly used. However, a major drawback associated with the solvent-based inks exists in their anti-environmental characteristics as this type of inks tends to include high concentration of volatile organic compounds, which is foreseeable to have restriction in the field.

In addition, the aforementioned types of inks can be outputted via inkjet devices. Traditionally, inkjet technology of the inkjet devices can be categorized to two types, including Thermal Bubble Inkjet and Piezoelectric Inkjet. Nevertheless, a number of drawbacks associated with the aforementioned inkjet technologies still exist, which mainly relate to the inks contained in these devices. For example, the blocking of the inkjet printing head caused by the undesired properties of the inks adapted by the inkjet technology or the extra costs of wasted inks required for cleaning the inkjet printing head to prevent the blocking thereof, which significantly reduces the efficiency of the inkjet printing economically.

Also, for traditional inks, the basic color gamut mostly falls within the CMYK gamut for conventional printings. However, the range of color constituting such color gamut only covers a small portion of an entire color spectrum, which does not allow effective tuning of vivid color.

Therefore, there is a need to provide a new nano-ranged wide color gamut and environmental-friendly UV inkjet printing system capable of overcoming the drawbacks of known arts.

### SUMMARY OF THE INVENTION

An objective of the present invention is to provide a nano-ranged wide color gamut and environmental-friendly UV inkjet printing system for application on a hard substrate, and the ink exhibits the merits of having a UV curable material, wide color gamut of RYBK, low water percentage, high adhesiveness and high transparency.

In order to achieve the aforementioned objective of the present invention, a nano-ranged wide color gamut and environmental-friendly UV inkjet printing system is provided for applying on a hard substrate, and the nano-ranged wide color gamut and environmental-friendly UV inkjet printing system comprises a carrier, an ink supplier, a printing head and a controller. In which, the carrier is provided for receiving the hard substrate thereon, and the ink supplier includes a container for containing an ink. A color gamut of the ink comprises basic colors of red, yellow, blue and black. The printing head is connected to the ink supplier to receive the ink from the ink supplier, and the controller is connected to the printing head and is capable of generating a control signal to control the printing head to print the ink onto a surface of the hard substrate directly.

In comparison with the known art, the present invention provides a nano-ranged wide color gamut and environmental-friendly UV inkjet printing system for application on a hard substrate, wherein the ink comprises a UV curable composition and the color gamut of the ink comprises basic colors of red, yellow, blue and black to form a vivid color gamut, (or the so-called wide color gamut). Furthermore, the ink includes the merits of being environmental friendly, resistant to heat, easy for preservation, rapid drying, high adhesiveness, high transparency, low ink diffusion and high resolution reaching about 1440 dpi.

### BRIEF DESCRIPTION OF THE DRAWINGS

FIG. 1 is a block diagram showing an embodiment of the nano-ranged wide color gamut and environmental-friendly UV inkjet printing system; and

FIG. 2 is an illustration showing the color gamut of the ink of FIG. 1 in the color spectrum.

### DESCRIPTION OF EMBODIMENTS OF THE INVENTION

To understand the objectives, features and effects of the present invention, the following detailed description of the embodiment of the present invention is provided along with the accompanied drawings to further describe the present invention in greater detail as follows.

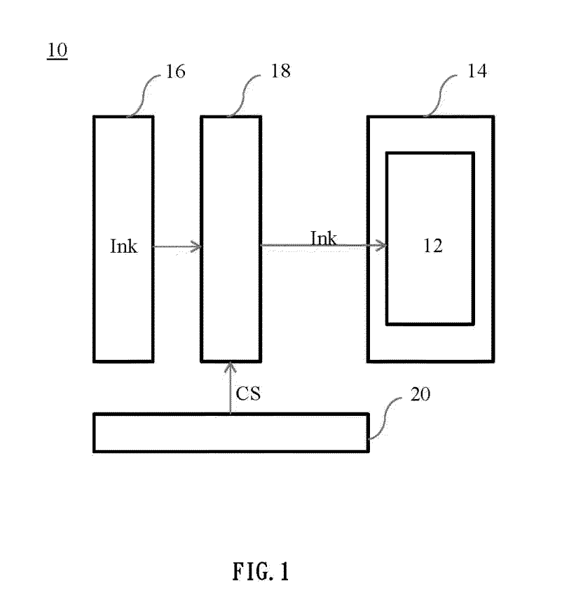

Refer now to FIG. 1 that shows a block diagram of an embodiment of a nano-ranged wide color gamut and environmental-friendly UV inkjet printing system of the present invention. As shown in FIG. 1, the nano-ranged wide color gamut and environmental-friendly UV inkjet printing system 10 is provided for a hard substrate 12, and the hard substrate 12 can be any one of the forms of canvas fabric, stick, lighting box and tile. In addition, the material of the hard substrate 12 can be any one of the following of polyvinyl chloride (PVC), polyethylene terephthalate (PET), polymethylmethacryslate (also known as acrylic), acrylonitrile butadiene styrene (ABS), poly carbonate (PC), glass and tile.

The nano-ranged wide color gamut and environmental-friendly UV inkjet printing system 10 of the present invention comprises a carrier 14, an ink supplier 16, a printing head 18 and a controller 20.

The carrier 14 is provided for carrying the hard substrate 12 thereon such that the hard substrate 12 is secured onto the nano-ranged wide color gamut and environmental-friendly UV inkjet printing system 10 so that the hard substrate 12 will be fixed.

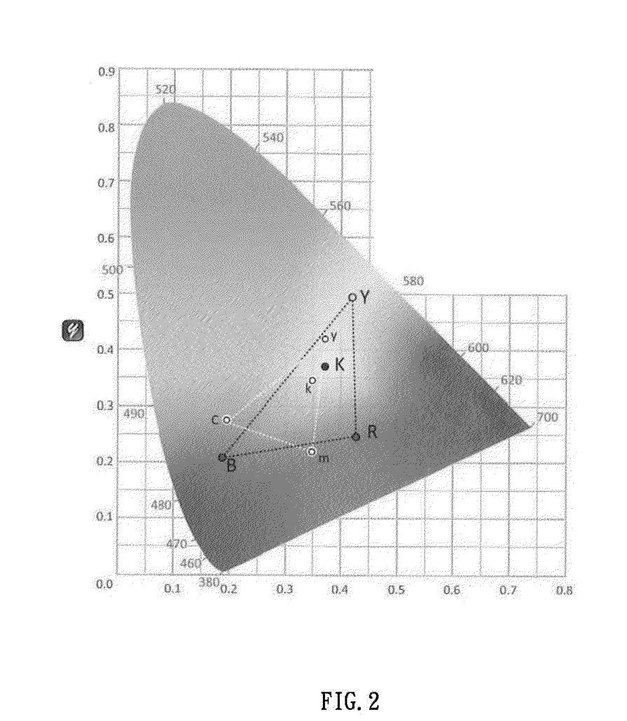

The ink supplier 16 is formed to include a container (not shown in the figure) for containing an ink, and a color gamut of the ink comprises basic colors of red (R), yellow (Y), blue (B) and black (K), which are known as the RYBK color gamut, as shown in both FIGS. 1 and 2. Furthermore, FIG. 2 also shows the CMYK color gamut for traditional printings in addition to the abovementioned color gamut of the ink of the present invention, and the comparison of the two reveals that the color gamut of the ink of the present invention is clearly wider than the one of the CMYK color gamut. In another embodiment of the present invention, the ink supplier 16 can be of a form of an ink cartridge. Furthermore, in another embodiment of the ink of the present invention, not shown in FIG. 2, the basic colors of the ink further comprise at least one of the colors of light blue and light red such that the changes of the color gamut can be more vivid than the one of the RYBK and such that the tuning of the colors can be more flexible.

The ink of the present invention is composed by at least one of photopolymerizable prepolymer, photosensitive monomer, photopolymerization initiator, mixing agent, environmental-friendly color paste and addition agent; wherein the photopolymerizable prepolymer is one of the following of cleavage-type initiator, photo-initiator and ionic initiator; and wherein the addition agent further comprises at least one of emulsifier, surfactant and UV absorbent.

The ink of the present invention comprises a UV curable compound (i.e. the abovementioned photopolymerization initiator) for curing the ink into a solid form on the hard substrate 12 upon receiving a UV light shone thereon. The photopolymerization initiator is a compound that can be excited easily by light; in other words, the ink can be excited to free radicals by absorbing UV light and is able to be cured into a solid in reaction to the light by transferring the energy to the photosensitive molecules or photocrosslinking agent. In addition, the photopolymerizable prepolymer, also known as the oligomer, comprises low polymers of unsaturated functional group which is the most crucial composition of the photo-environmental-friendly type. Furthermore, the wavelength of the UV light for curing the ink is equivalent to one of the following of 395 nm, 405 nm and 450 nm. Also, since the UV light cannot directly break the double-bonding of the photopolymerizable prepolymer, the photosensitive material would not be cured into solid rapidly in the absence of the photopolymerization initiator. Therefore, in general, a small amount of the photopolymerization initiator is added in the ink such that when the photopolymerization initiator of the ink is exposed to the UV light and the photopolymerization initiator receives photons therefrom, it would then be decomposed into free radicals and start the bonding reaction, which then causes the unsaturated double-bonding to undergo a polymerization reaction, the polymer molecules to form interlaced net structures continuously and the ink to be cured into solid as the free radicals lose the mobility and the boding ceases to grow. Accordingly, the photopolymerizable prepolymer is one of the following of cleavage-type initiator, photo-initiator and ionic initiator.

Furthermore, the ink of the present invention consists of a plurality of particles, and wherein the particle size is nano-ranged, or in the nano range; for example, the particle size of the ink is between 50 nm and 300 nm.

Additionally, the operating temperature of the ink is between 15° C. and 32° C., the preservation temperature of the ink is between 15° C. and 35° C. and the operating humidity of the ink is between 50% and 70%.

Furthermore, the photosensitive monomer is a small-molecule compound having an unsaturated group (such as double-bonding) such that it can be reacted with the abovementioned oligomer to form bonding under UV light and the mole thereof is between several hundred to several thousands.

In addition, the viscosity of the ink can be adjusted by adding viscous prepolymers into an active diluted agent such that the solid bonding density of the ink can be further controlled in order to improve the physical property, such as the softness and hardness, of the ink cured by the UV light. Accordingly, the active diluted agent can be categorized as the single-functional-group diluted agent and the multi-functional-group diluted agent. From the effect of dilution and the rate of curing of the multi-functional-group active diluted agent, it can be realized that they are of better performance than the ones of the single-functional-group active diluted agent. Furthermore, since the active diluted agent has significant effects on the curing process and the property of the cured membrane of the ink, it is important to select a suitable active diluted agent. In general, one must consider the viscosity, functionality, volatilization, odor, toxicity and solubility of the photosensitive monomer. For most cases, the common active diluted agent can be tripropylene glycol diacrylate (TPGDA), tetraethylene glycol diacrylate (TEGDA) and trimethylolpropane triacrylate (TMPTA).

The mixing agent is used for diluting the ink and is provided as a carrier for the ink. Furthermore, the types of the mixing agent as well as the amount of its usage have significant effects on the stability of the ink. Organic agents including low-boiling-point alcohol, high-boiling-point alcohol, ether, ammonia and ester and having prominent effects on improving the stability of the ink can be selected for further mixing and production of the ink such that the ink produced is of qualified stability, viscosity, surface tension and electrical conductivity satisfying the performance requirement of the ink. In another embodiment, the mixing agent is selected from the group of acetic ester, acetic acid butyl ester and acetic acid isopropyl ester.

Refer now to FIG. 1 again. The printing head 18 is connected to the ink supplier 16 such that the printing head 18 receives the ink from the ink supplier 16. In another embodiment, the printing head 18 comprises an ink clamping container (not shown in the figure) provided for receiving the ink supplier 16 in a form of the ink cartridge.

The controller 20 is connected to the printing head 18. In addition, the controller 20 is able to generate a control signal CS to control the printing head 18 to spray coating the ink directly onto the surface of the hard substrate 12. As an example, the controller 20 can be a single chip or a microprocessor.

In comparison with the known art, the present invention provides a nano-ranged wide color gamut and environmental-friendly UV inkjet printing system 10 for a hard substrate 12, wherein the ink comprises a UV curable compound and the color gamut of the ink comprises basic colors of red, yellow, blue and black to form a vivid color gamut, or the so-called wide color gamut. Furthermore, the ink includes the merits of being environmental friendly, resistant to heat, easy for preservation, rapid drying, high adhesiveness, high transparency, low ink diffusion and high resolution reaching about 1440 dpi.

The abovementioned embodiments are provided to illustrate the principles and exemplary methods of manufacturing or formation method of the present invention only. The scope of the present invention shall be defined by the claims recited hereafter, and any modifications or variations to the terms or wordings recited in the claims shall be considered as their relevant equivalence and are within the scope of the present invention. The scope of the present invention shall be determined by the content of the claims recited hereafter.

What is claimed is:

1. A nano-ranged wide color gamut and environmental-friendly UV inkjet printing system for a hard substrate, the nano-ranged wide color gamut and environmental-friendly UV inkjet printing system comprising:
a carrier for receiving the hard substrate thereon;
an ink supplier unit that form a container space for containing the ink including a container for containing an ink; wherein a color gamut of the ink comprising basic colors of red, yellow, blue and black;
a printing head connected to the ink supplier to receive the ink from the ink supplier; and
a controller connected to the printing head and generating a control signal to control the printing head to print the ink onto a surface of the hard substrate directly.

2. The nano-ranged wide color gamut and environmental-friendly UV inkjet printing system as claimed in claim 1, wherein the ink further comprises a UV curable compound for curing the ink into a solid form on the hard substrate upon receiving a UV light shone thereon.

3. The nano-ranged wide color gamut and environmental-friendly UV inkjet printing system as claimed in claim 2, wherein a wavelength of the UV light is equivalent to one of the following of 395 nm, 405 nm and 450 nm.

4. The nano-ranged wide color gamut and environmental-friendly UV inkjet printing system as claimed in claim 2, wherein the ink comprises at least one of photopolymerizable prepolymer, photosensitive monomer, photopolymerization initiator, mixing agent, environmental-friendly color paste and addition agent.

5. The nano-ranged wide color gamut and environmental-friendly UV inkjet printing system as claimed in claim 4, wherein the addition agent further comprises at least one of emulsifier, surfactant and UV absorbent.

6. The nano-ranged wide color gamut and environmental-friendly UV inkjet printing system as claimed in claim 4, wherein the photopolymerizable prepolymer is one of the following of cleavage-type initiator, photo-initiator and ionic initiator.

7. The nano-ranged wide color gamut and environmental-friendly UV inkjet printing system as claimed in claim 2, wherein a size of the ink is between 50 nm and 300 nm.

8. The nano-ranged wide color gamut and environmental-friendly UV inkjet printing system as claimed in claim 1, wherein the hard substrate is of a material of any one of the following of polyvinyl chloride, polyethylene terephthalate, polymethylmethacryslate, acrylonitrile butadiene styrene (ABS), poly carbonate, glass and tile.

9. The nano-ranged wide color gamut and environmental-friendly UV inkjet printing system as claimed in claim 8, wherein the hard substrate is a form of any one of the following of canvas fabric, sticker, lighting box and tile.

10. The nano-ranged wide color gamut and environmental-friendly UV inkjet printing system as claimed in claim 1, wherein the operating temperature of the ink is between 15° C. and 32° C., a preservation temperature of the ink is between 15° C. and 35° C., and an operating humidity of the ink is between 50% and 70%.

11. The nano-ranged wide color gamut and environmental-friendly UV inkjet printing system as claimed in claim 1, wherein the basic colors of the ink further comprise at least one of the following colors of light blue and light red.
